(19) United States
(12) Patent Application Publication
(10) Pub. No.: US 2008/0270038 A1
(43) Pub. Date: Oct. 30, 2008

(54) SYSTEM, APPARATUS AND METHOD FOR DETERMINING COMPATIBILITY BETWEEN MEMBERS OF A SOCIAL NETWORK

(76) Inventors: Hadi Partovi, Seattle, WA (US); Ali Partovi, Piedmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/108,431

(22) Filed: Apr. 23, 2008

Related U.S. Application Data
(60) Provisional application No. 60/913,776, filed on Apr. 24, 2007.

(51) Int. Cl. G06F 19/00

(52) U.S. Cl. 702/19

(57) ABSTRACT

A system, apparatus, and method are provided to assist users to access and process information about a group of friends who are members of a third party social network in order to determine compatibility between the user and each friend or determine the most-compatible friends within that social network. In some embodiments, the system and method may obtain login or other authentication data regarding a user to access the user information on the third party social network, such as a list of friends (e.g., a buddy list) specified within the third party social network. After accessing the list of friends, information regarding each friend's preferences, interests, likes, dislikes, etc. may also be obtained from the third party social network. Subsequently, a compatibility measure between the user and each friend in the list is determined based on the obtained information regarding the friend and the user. The resulting compatibility measures may be filtered, sorted, ranked, or otherwise processed or acted upon prior to, or after presentation to the user.

### CROSS-REFERENCES TO RELATED APPLICATIONS

The present application claims benefit to U.S. Provisional Patent Application No. 60/913,776, filed Apr. 24, 2007 the complete disclosure of which is incorporated herein by reference.

### BACKGROUND

The present invention is directed to social networks and social networking applications, and more specifically, to a system and method for determining compatibility between a user and a group of “friends” who are part of the same social network.

With the rapid increase in interest in social networks and social networking applications, users of such networks (e.g., MySpace, Facebook, etc.) often have designated dozens or even hundreds of other network members as “friends”. While social networks provide entertainment and social value by “adding” other members to a “friends” list, users sometimes aim to have the largest list of friends (numbering in the 100s). In such cases, it is very difficult or nearly impossible to filter through the available information about each “friend” to determine the most relevant information about a friend or group of friends' interests, likes, dislikes, etc. This limits the utility of the “friend” designation and reduces its value, since not every “friend” may have enough common interests or other characteristics to warrant further communication or exchange of information about certain topics. Also, when a user wants to discuss or communicate about a certain topic of interest, it is often difficult to know which of their “friends” share the same interest.

A number of companies provide content compatibility measures or calculators within their own network. For example, such companies include Last.fm (which calculates music-compatibility among friends), Flixster (which calculates movie-compatibility among friends), Netflix (which calculates movie-compatibility among friends), and the like. Note that in the examples given, the network is a proprietary one that uses its own heuristic or method to determine compatibility, and that in order to determine a compatibility measure, both the user and the “friend” of interest must belong to the network that determines the compatibility measure. However, a user may want to know the most compatible friend among friends who are associated with some other social networks. The social network providing compatibility measure or calculation may require all of the friends to join the social network in order to calculate the compatibility between the user and the friends. This can be a detriment to determining compatibility as not every group of friends may be interested in joining the same social network or adding yet another network membership to those they are already associated with. For example, a user and their friends may all be members of a social network such as Facebook, which doesn't provide a built-in measure of friend-compatibility. What is desired is a system, apparatus, and method for determining the compatibility between two members of a social network that overcomes the disadvantages of present approaches.

### SUMMARY

A system, apparatus, and method are provided to assist users to access and process information about a group of friends who are members of a third party social network in order to determine compatibility between the user and each friend or determine the most-compatible friends within that social network. In some embodiments, the system and method may obtain login or other authentication data regarding a user to access the user information on the third party social network, such as a list of friends (e.g., a buddy list) specified within the third party social network. After accessing the list of friends, information regarding each friend's preferences, interests, likes, dislikes, etc. may also be obtained from the third party social network. Subsequently, a compatibility measure or score between the user and each friend in the list is determined based on the obtained information regarding the friend and the user. The resulting compatibility measures may be filtered, sorted, ranked, or otherwise processed or acted upon prior to, or after presentation to the user.

In contrast to existing systems that require creation of, or joining a separate social network for calculation of interest, content or other form of compatibility, embodiments of the present invention enable a user of any third party social network (e.g., MySpace, Facebook, Friendster) to calculate their compatibility with their friends within their existing network (i.e., without joining a new network just to calculate compatibility scores for content or information about the user and their “friends” within that network).

In an accordance with one embodiment, a method for providing a compatibility measuring service for a user on a third party social network is provided. The method includes receiving a request for a compatibility measuring service, and obtaining, from the user, permission to access one or more third party social networks to collect information relating to the compatibility measuring service. The third party social network is accessed by passing the permission to the third part social network. A list of friends designated by the user within the third party social network and information about the user are obtained. For each friend in the list, information about the friend, such as preferences, interests, likes, dislikes, etc. is obtained from the third party social network and processed to identify a set of information that will be used for calculating a compatibility measure between the user and the friend. In some embodiments, the user may be asked to provide additional information about their own tastes, to be used in calculating their compatibility with friends. Subsequently, a compatibility measure between the user and the friend is determined. The determined compatibility measure and identification information about the friend are stored with the service server. A resulting list of friends is generated as an output based on the sorted, filtered, ranked, or processed compatibility measures.

In an accordance with another embodiment, a server is provided for determining a user's compatibility with a group of friends where the user and the group of friends are members of a social network. The social network is implemented independently from the service server. The service server comprises a database for storing information about the user, and a set of compatibility measuring (calculating) rules and a computing device communicatively coupled to the database. The computing device obtains permission from the user to access information about the user from the social network or social networks. Upon obtaining the permission, the computing device accesses the social network to obtain a list of friends in the social network. For each friend in the list, information about the friend is obtained from the social network and processed to identify a set of information relevant to calculating a compatibility measure. Subsequently, a compatibility measure or score between the user and the friend is determined. A resulting list of friends is generated as an output based on the sorted, filtered, ranked, or processed compatibility measures. Alternatively, the most compatible friend is selected based on the sorted, filtered, ranked, or processed compatibility measures. Identification information about the most compatible friend is presented to the user.

### BRIEF DESCRIPTION OF THE DRAWINGS

FIG. 1 is a block diagram illustrating an example of an environment for implementing aspects in accordance with various embodiments of the present invention;

FIG. 2 is a flowchart illustrating a routine for determining compatibility measures between a user and a list of friends who are both members of a same social network, in accordance with some embodiments of the present invention;

FIGS. 3A-3F are exemplary screen displays where the user interacts with the service server for determining compatibility measures between the user and another user (friend) who are both members of a social network, in accordance with some embodiments of the present invention; and

FIG. 4 is a flowchart illustrating a subroutine used in FIG. 2 for calculating a compatibility measure between the user and a friend from the list, in accordance with some embodiments of the present invention.

### DETAILED DESCRIPTION

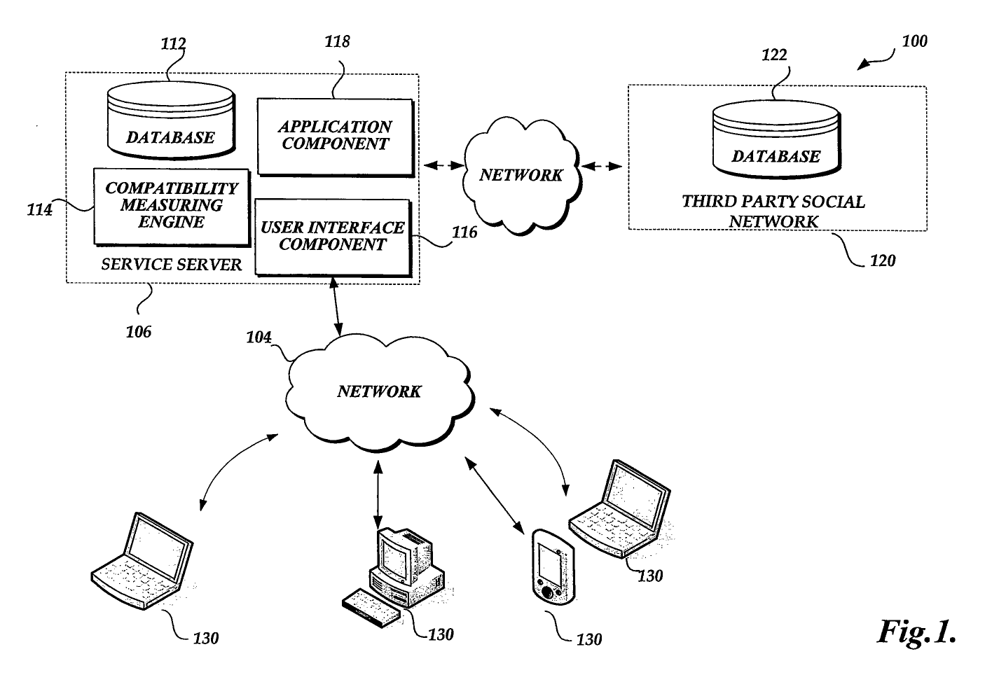

FIG. 1 illustrates an example of an environment 100 for implementing aspects in accordance with various embodiments. As will be appreciated, different environments may be used, as appropriate, to implement various embodiments. The environment 100 shown includes an electronic user device 130, which can include any appropriate device operable to send and receive requests, messages, or information over an appropriate network 104 and convey information back to a user of the device. Examples of such client devices include personal computers, cell phones, handheld messaging devices, laptop computers, personal data assistants, and the like. The network can include any appropriate network, including an intranet, the Internet, a cellular network, a local area network, or any other such network or combination thereof. Protocols and components for communicating via such a network are well known and will not be discussed herein in detail. Communication over the network can be enabled by wired or wireless connections, and combinations thereof. In this example, the network includes the Internet, as the environment includes a web-based compatibility service 106 for receiving requests and serving compatibility comparisons in response thereto, although for other networks an alternative device serving a similar purpose could be used as would be apparent to one of ordinary skill in the art.

The environment in one embodiment is a distributed computing environment utilizing several computer systems and components that are interconnected via communication links, using one or more computer networks or direct connections. However, it will be appreciated by those of ordinary skill in the art such a system could operate equally well in a system having fewer or a greater number of components than are illustrated in FIG. 1. Thus, the depiction of the system 106 in FIG. 1 should be taken as being illustrative in nature, and not limiting to the scope of the disclosure.

The illustrative environment further includes at least one application server 106 including an application component 118, a compatibility measuring engine 114, a user interface component 116, and a database 112. The application server 106 typically will include an operating system that provides executable program instructions for the general administration and operation of that server, and typically will include a computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

In one embodiment, the application server 106 is a web-based social network service server. The web-based social network service server (hereinafter, service server) provides various services related to the social network including a compatibility measure service for the users. Example of services that can be provided by the service server include, but are not limited to, recommending a product or a service, campaigning a targeted advertisement, providing a community message board, etc. Once registered with the service server, each user can request to locate a most compatible friend from a list of friends for given criteria or view a list of friends that are sorted by a degree of compatibility or similarity.

As will be described in a greater detail below, the systems and methods access and process information about a group of friends who are members of a social network in order to determine the most-compatible friends within that network, or obtain compatibility measures of the group of friends. In some embodiments, the system and method may obtain login or other authentication data regarding a user to enable the service server 106 to retrieve information from the third party social network in order to calculate compatibility. For example, the service server 106 can directly access the user's “friend” list and associated data from another social network 120 using the login credential of the user. The term “friend,” as used herein, refers to another user who is a member of a social network 120 and is identified or designated as a friend implicitly or explicitly by the user. Within a social network, a user generally maintains a “list of friends” for sharing information or communicating each other. One example may be a buddy list selected by the user in a particular social network. The term “list of friends”, as used herein, refers to a group of friends whom the user indicates or specifies as a friend within the social network. In some cases, the list of friends may not be readily available on Web pages of the user. In such cases, the information relevant to determining friends of the user may be accessed and processed to get the list of friends. For the purpose of discussion, it is assumed that the list of friends can be accessed and obtained from the social network with an appropriate access right. After accessing the list of friends in the social network, information regarding each friend's preferences, interests, likes, dislikes, etc. may be obtained from the social network. Subsequently, a compatibility measure between the user and each friend in the list may be determined based on the obtained information about the friends and information about the user. The resulting compatibility measures may be filtered, sorted, ranked, or otherwise processed or acted upon prior to, or after presentation to the user.

The database 112 can include several separate data tables, databases, or other data storage mechanisms and media for storing data relating to a particular aspect. For example, the database illustrated includes mechanisms for user profile information, a list of friends (the user can provide such information at the time of registration or the list of friends have been previously obtained), user preferences, other collected and obtained information, etc. The database 112 is operable, through logic associated therewith, to receive instructions from the service server 106, and obtain, update, or otherwise process data in response thereto.

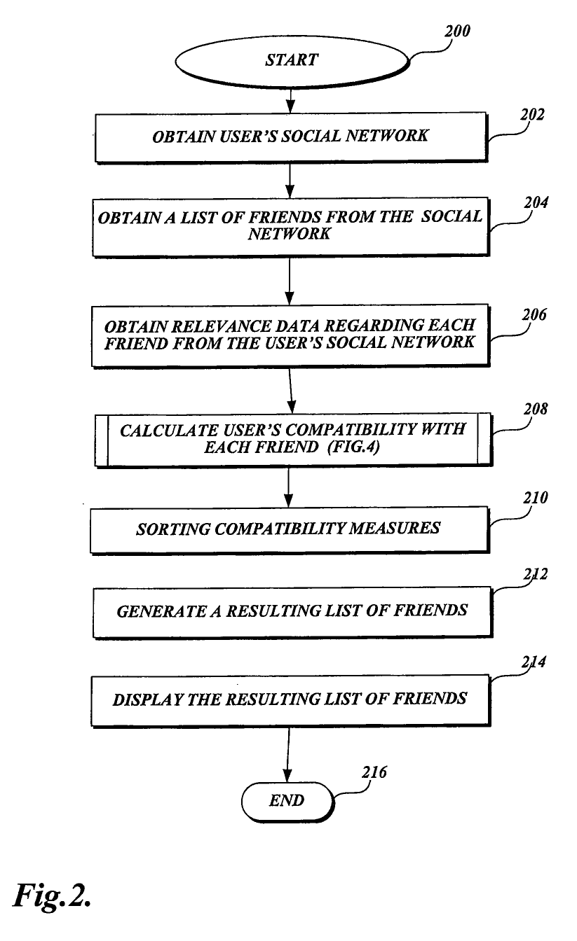

Referring to FIG. 2, a flowchart 200 illustrates a method for determining a compatibility measure between a user and a friend who are both members of a same third party social network, in accordance with some embodiments of the present invention. It is understood that the description is exemplary and that other methods, processes, etc. may be utilized and fall within the concept of the invention.

Beginning with block 202, the compatibility measuring engine 114 or the service server 106 obtains user's social network information. For the sake of discussion, it is assumed that the user has registered with the service server 106 that can access user's profile information, login credentials, etc. At the time of the registration, the user may be asked to provide social networks where the user is a member. In one embodiment, the service server 106 may store such information (associated social networks, etc.) in the user profile information. The user can view or update the user profile information anytime after the registration.

At block 204, the social network is accessed to obtain a list of friends specified or indicated by the user on the social network site. In some embodiments, the service server 106 obtains information relevant to determine friends of the user from the social network when the list of friends is not readily available. It is noted that the service server 106 typically does not have a way of access the user's information (related to the list of friends) stored with the third party social networks. Thus, the service server 106 may ask the user to provide the information that can be used to access the list of friends in the social network sites. For example, the list of friends can be obtained directly via a form asking the user for their username and password on the social network. As will be well appreciated, the list of friends may be a list, a file, or other forms of data containing an identification of those designated by a user as friends.

As will be discussed in greater detail below, there are several ways to collect, obtain, or process information, about a list of friends or each friend, relevant to determining the compatibility measure. In some embodiments, the service server 106 may obtain the list of friends from a screen display of the user's home page (Web page) on a social network site. In such embodiments, the service server 106 may collect login credentials for the user to enable access to the user's personal information on the social network. Using the collected login credentials, the service server 106 may access the Web page(s) of the user where the user generally lists or identify his/her friends. In general, the user may list or identify names of friends, login identifiers of friends, etc. in a certain section on Web pages. Alternatively, the service server 106 may direct the user to login to the social network site so that the service server 106 can access the user's Web page(s) on the social network site. Once the Web page(s) is accessed, the service server 106 collects information about the friends of the user, such as a list of friends, a buddy list, etc. After obtaining the list of friends, the service server 106 “scrapes” public information about each friend, such as Web pages of the friend, on the social network site.

As will be well appreciated, there are other ways to access information about the user's friends in the social network in question. In one embodiment, the service server 106 may be provided with an appropriate interface to the social network site. For example, some social network sites provide an API interface, or the like so that other services can access directly the social network sites through the provided API interface.

At block 206, the compatibility measuring engine 114 accesses relevant data regarding each “friend” from the user's social network. For each friend from the list of friends, the service server 106 accesses and collects data regarding the friend that are relevant to determining a compatibility measure between the user and the friend. Such data include, but are not limited to, the information about the friend's tastes, interests, preferences, favorite music, movies, sports, or book choices, dislikes, etc. For example, the information that the friend has provided to the social network regarding their preferences or interests, or other indicators of potential compatibility may be used in the compatibility determining method, heuristic, algorithm, etc.

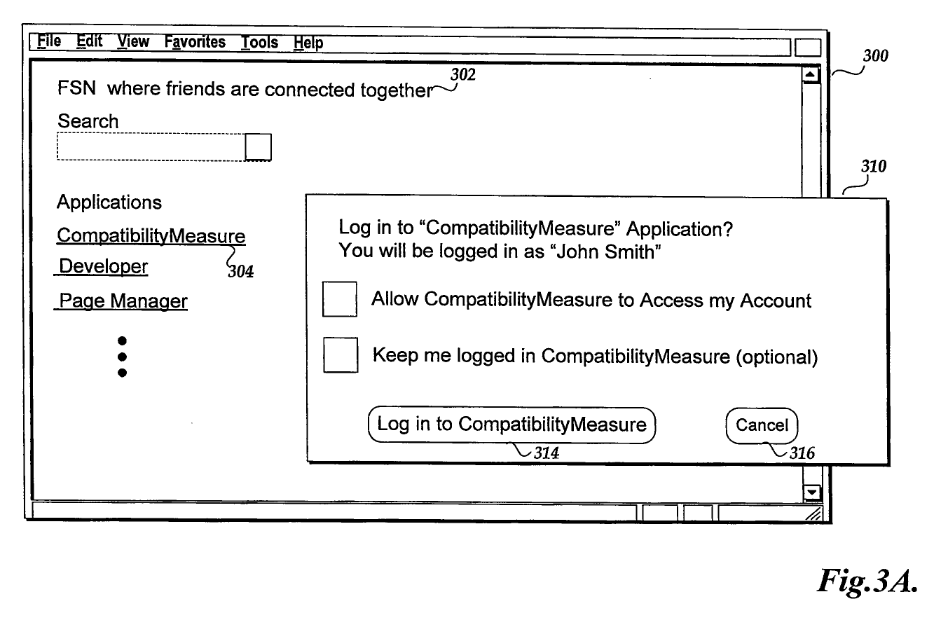

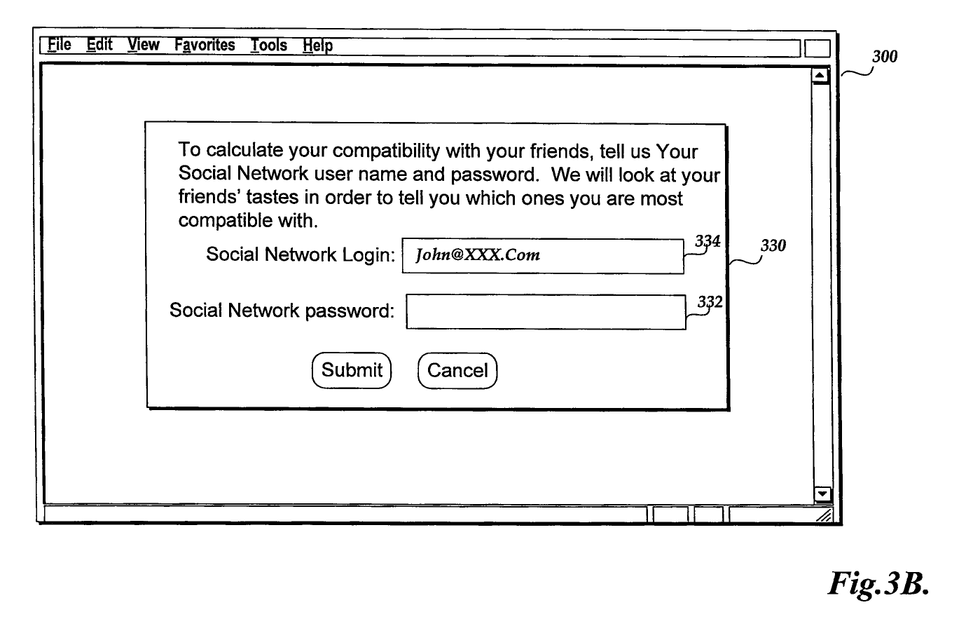

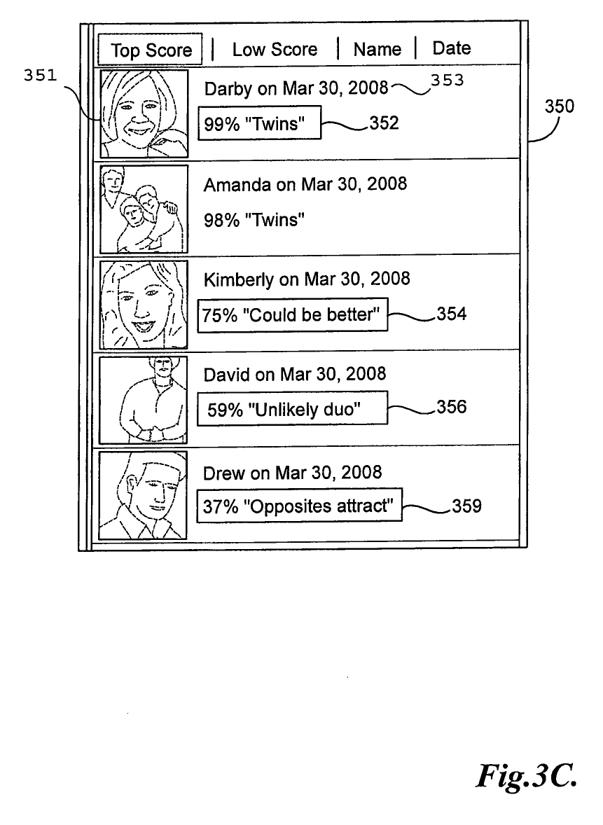

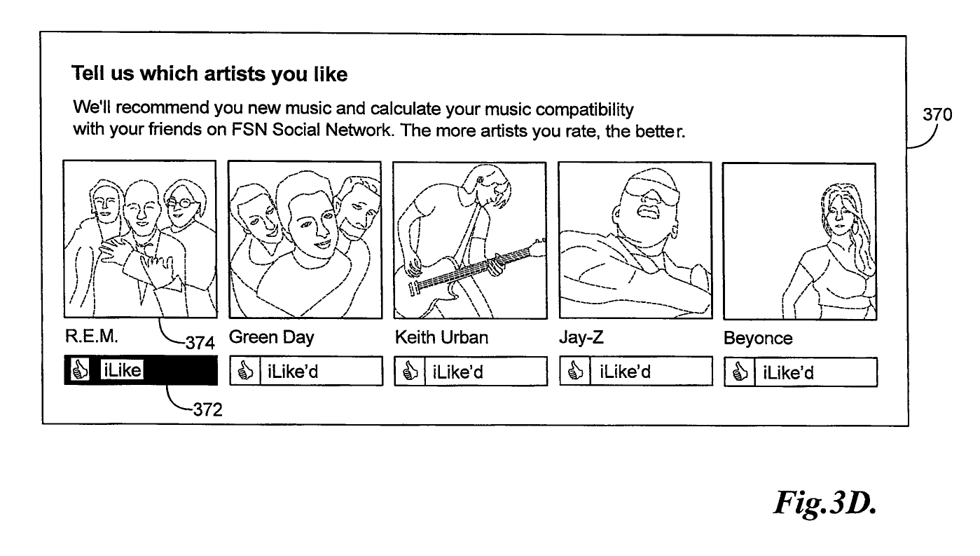

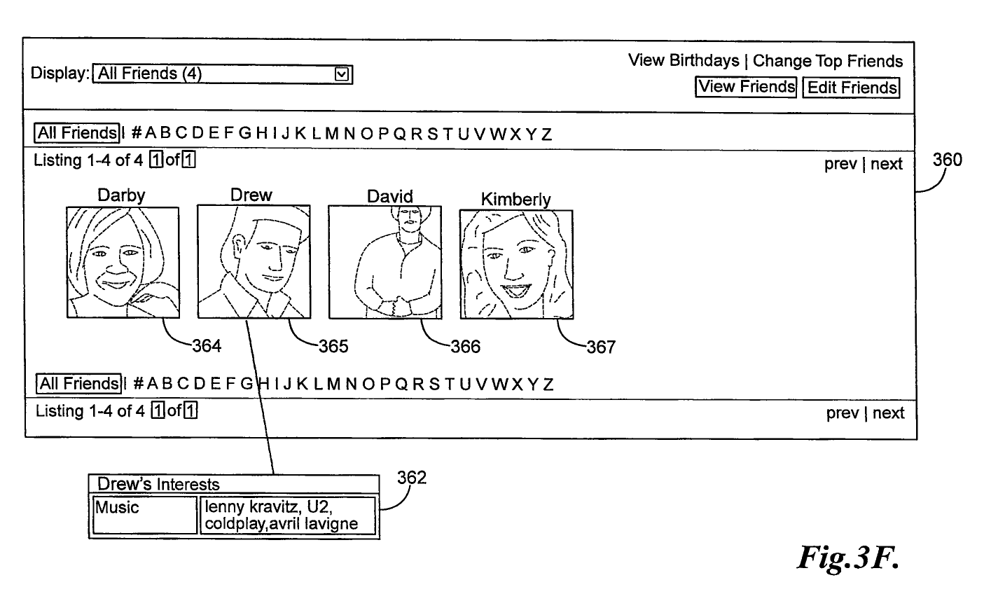

As briefly discussed above, the API-interface provided by the social network site may be used to retrieve or collect data from Web pages of the social network site. The retrieved data may be obtained from the friend's home page (Web pages) or other locations on the social network, and may be generic or specific to the compatibility measure being determined. In some cases, the social network may provide a suitable interface, such as the FQL, (query language for Facebook) for querying information. In such cases, the data can be obtained directly using the suitable interface for querying, e.g., a query language. Referring to FIG. 3A, an exemplary screen display 310 where the API-interface is employed for accessing the social network is depicted, in accordance with some embodiments. As shown, the user can start the compatibility measuring process for the friends who are members of the third party social network site. After the user confirms his/her intention to launch the compatibility measuring, the third party social network allows the compatibility measuring engine 114 or the service server 106 to directly access the third party social network data through the previously defined API interface.

In some embodiments, the data may be retrieved or collected through a “screen-scraping” technique or other suitable methods. Generally described, “screen scraping” is a technique in which a computer program extracts data from the display output of another program. The screen scraping also includes computerized parsing of the HTML text in Web Pages. Through the screen scraping, the server 106 can recognize and discard unwanted data, images, and display formatting. As mentioned above, the screen scraping is most often done to interface to a third-party system which does not provide a more convenient API interface. When the service server 106 employs the screen-scraping technique, the service server 106 uses direct HTTP requests to the social network web-servers. That is, the service server 106 passes in the user's authentication credentials, and subsequently makes HTTP requests to retrieve the list of the user's friends. For each friend in the list, the service server 106 accesses a screen display of the friend's Web page(s). Subsequently, the service server 106 retrieves and parses data from the display of the friend's Web page(s) on the social network site.

Referring now to FIG. 3B, an exemplary screen display 330 for obtaining the user's login credentials is depicted when the service server 106 employs the screen-scraping technique, in accordance with some embodiments. As shown, the user may be asked to provide the user login name 334 and the password 332 for the social network site. After the service server 106 passes in the user's authentication credentials (for example, user login name 334, password 332) to the social network site, the service server 106 makes HTTP requests to scrape Web pages of the user to retrieve the list of friends, or information relevant to determine the list of friends. FIG. 3F depicts an exemplary screen display of a Web Page that is scraped from a social network site, in accordance with some embodiments. After the relevant Web page is scraped, the user's friends 364-367 designated by the user in the social network, or information about a friend, for example, Drew's interests in Music information 362 may be parsed from the scraped screen. In some cases, after the list of friends is parsed from the scraped screen, a screen of each friend's Web page may be scraped and parsed to obtain information about the friend, such as preferences, interests, likes, dislikes, etc.

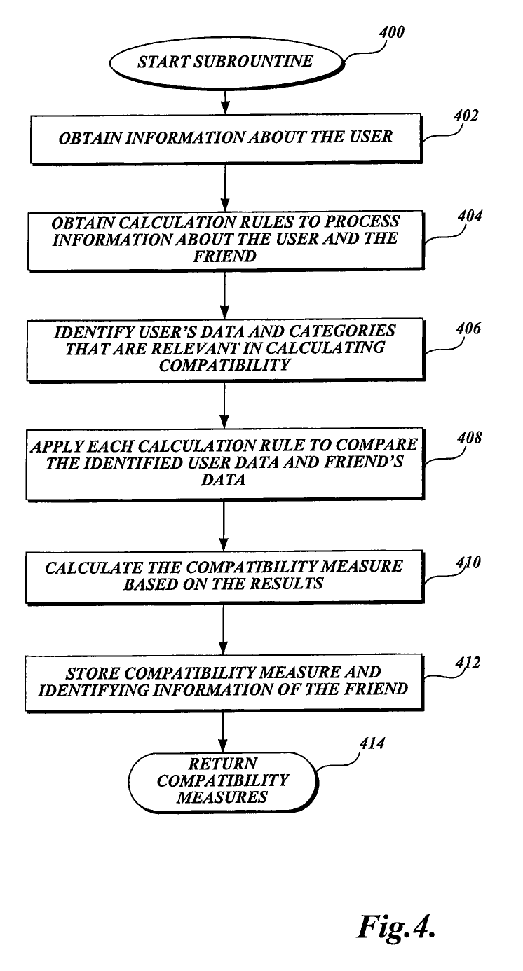

At block 208, the compatibility measuring engine 114 calculates a compatibility measure between the user and each friend. The calculated (measured) compatibility measure may be associated with the friend's name or identifier and stored in the database 112 for further processing, sorting, or filtering. The compatibility measure calculation will be discussed in a greater detail below in connection with FIG. 4. Briefly stated, during the calculation, the data about each friend are compared to the same category or related data about the user (e.g., favorite Music, Movies, TV Shows, Books, Activities, Interests, Photos, etc). Based on such comparison, a compatibility measure between the user and the friend may be determined. It is noted that there are various possible methods to measure compatibilities among data. In one embodiment, the compatibility measure may be determined using one or more of multiple possible methods: (a) counting the % of overlapping tastes (e.g., “we both like Hamlet”); (b) calculating a “Cosine Similarity” measure between the data sets; or (c) introducing contextual or other knowledge to modify a similarity determination (such as “Joe likes Hamlet, John likes Romeo & Juliet” indicating a similar interest). After the compatibility calculation, the calculated compatibility measure and relevant information for each friend in the list may be returned and stored for later sorting, filtering or processing. Examples of this additional relevant information may be a list of artists that the two users share in common.

At block 210, after calculating the compatibility measure with each friend, the compatibility measures are sorted or filtered to generate an output, such as a resulting list of friends, or to locate the most compatible friend. At block 212, the generated output (the resulting list of friends) is displayed along with the capability measure score and relevant information. In some embodiments, a list or other data formats showing the user's friends is displayed along with an indication of the determined compatibility between the user and each friend. The display may include identifying information about each friend (e.g., name, photo, identifier, etc.), a value of the compatibility measure, additional information regarding the friend, how the compatibility measure was determined, compatibility rankings, areas or categories of highest compatibility, etc. In addition, upon the user's request, the list of friends and their compatibility measure scores may be further sorted, filtered, etc. based on different criteria, such as compatibility score, age similarity, or geographical closeness, etc.

### Example Query Language

As described above, in some cases, a third party social network site may provide a suitable interface, such as the FQL, (query language for Facebook) for querying information. In such cases, the data can be obtained directly from the third party social network site using the suitable interface for querying, e.g., a query language. The below is an example of a query language provided by a social network site. In particular, the Facebook FQL query language is depicted when it is used to retrieve a list of friends, including their name, picture, and music tastes:

SELECT name, music, pic FROM user WHERE uid IN (SELECT
uid2 FROM friend
WHERE uid1=25695)

The below is an example of the information returned in response to the query:

```
<?xml version=“1.0” encoding=“UTF-8”?>
<fql_query_response xmlns=“http://api.facebook.com/1.0/”
xmlns:xsi=“http://www.w3.org/2001/XMLSchema-instance” list=“true”>
  <user>
    <name>Jonathan Man</name>
    <music>Phil Vassar, Johnny Cash, Alan Jackson, Tim
    McGraw</music>
    <pic>http://photos-
    070.facebook.com/ip003/profile/1232/48/s1070_13548.jpg</pic>
  </user>
  <user>
    <name>Mark Zuckerberg</name>
    <music>Green Day, U2, Coldplay</music>
    <pic>http://photos-
    004.facebook.com/ip002/v52/1240/77/s4_4802.jpg</pic>
  </user>
...
</fql_query_response>
```

### Example Screen Scraping

In some embodiments, to collect similar information on a social network that does not provide a direct API like the Facebook FQL query language, after the authentication/login step, the service server 106 may perform the following or similar “screen-scraping” HTTP requests:
i) HTTP request to retrieve the “all friends” HTML page for the User, with URLs to each friend profile
ii) For each friend, an HTTP request to retrieve that friend's profile page, which can then be parsed for relevant information (favorite music, movies, TV shows, activities, interests, photos, etc).
   Exemplary Screen display

It is noted that a possible output of some embodiments may be a standard display that may be in the form of a table of the user's friends, each listed with the friend's identifying information (e.g., name, photo), and a compatibility score (value of the compatibility measure) between the user and the friend. Referring now to FIG. 3C, an exemplary screen display 350 depicts an output presenting the resulting list of friends and the most comparable friend based on the compatibility measures, or scores in accordance with some embodiments. In certain embodiments, the service server 106 may have predefined compatibility levels, for example, “Twins” 352, “Could be better” 354, “Unlikely Duo” 356, “Opposites Attract” 359, and the like. Each compatibility level has a threshold range of compatibility measures. For example, the “Twins” level 352 may be determined if a compatibility measure falls in a range of 100% and 90% compatibility and “Could be better” level may be determined if a compatibility measure falls in a range of 75% and 89% compatibility, and so forth. In one embodiment, the service server 106 may be configured to sort the list of friends by the predefined compatibility levels. As shown in FIG. 3C, the friend's profile information, such as an image 351 (e.g., any type of a graphic representation, avatar, photo, etc.), identification information 353 (e.g., name, identifier, nick name), city and state, etc., associated with the friend may be presented to the user as part of the resulting list of friends. In addition, the service server 106 may present the resulting list of friends along with the compatibility level 353-359 for the friend, a brief description about each compatibility level, etc. to the user.

In another embodiment, the service server 106 may be configured to filter the list of friends to show the most-compatible friends, for example the top three most compatible friends or the single most compatible friend. As will be well appreciated, a typical format for such a display would be an HTML page or table, with links to sort friends by compatibility level, or to filter to show most-compatible friends. The service server 106 may provide the user with additional information that helps the user to understand the compatibility measure process or score. For example, the service server 106 may present the output indicating the heuristic, algorithm, rules, etc. that are used to generate the compatibility measure, as well as the data used in determining the compatibility measure. The service server 106 may provide the user with the obtained and collected information about the friends relevant to calculating the compatibility measure. In a case where several most compatible friends are determined, the user may request the service server 106 to find one or two most compatible users among the resulting friends list. The service server 106 may obtain additional information from the user or from the social network and perform the compatibility measure calculation between the user and each friend from the resulting friends list.

In some embodiments, the service server 106 may allow the user to select a set of criteria or categories of the data that are to be used in determining compatibility measure for friends in a particular social network. That way, the user can choose the most compatible friend(s) for given categories or a community. For example, the user can indicate the favorite Music, Movie, and TV shows categories to be used when the service server 106 determines the most compatible friend in a media social network site. In one embodiment, the user can rank the categories or the set of criteria. The ranking information may also be used to scale certain categories for compatibility measuring.

Referring now to FIG. 4, a flow diagram implementing a sub-routine 400 for calculating a compatibility measure between a user and a friend in accordance with some embodiments. During the calculation, the data about each friend are compared to the same or related data about the user (e.g., favorite Music, Movies, TV Shows, Books, Activities, Interests, Photos, etc.). Based on such comparison, a compatibility measure between the user and the friend may be determined. It is noted that there are various possible methods to measure compatibilities among data. In one embodiment, the compatibility measure may be determined using one or more of multiple possible methods: (a) counting the % of overlapping tastes; (b) calculating a “Cosine Similarity” measure between the data sets; or (c) introducing contextual or other knowledge to modify a similarity determination.

Beginning with block 402, the compatibility measuring engine 114 or the service server 106 106 obtains information about the user, including preferences, favorite Music, Movies, TV Shows, Books, Activities, Interests, Images, dislikes, etc. In one embodiment, such information about the user may be stored with the database 112 coupled to the compatibility measuring engine 114. As discussed above, additional information about the user may also be retrieved or collected from the social network site. In one embodiment, the user may be asked to provide a particular category of information. For example, a user may be asked to rate their favorite music or musician. Referring to FIG. 3D, an exemplary screen display 370 where the user can select their favorite artists is depicted in accordance with some embodiments. As shown, the server 106 presents the user with a list of the artists and asks the user to select his/her favorite artists. Upon user's selection 372, information about the artist may be obtained and parsed to filter relevant information. As such, the server 106 may actively collect information from the user in order to enhance the resulting compatibility measures. At block 404, the compatibility measuring engine 114 obtains a set of calculation rules to process the user and the friend's data. As discussed above, one or more measuring methods can be used to determine a compatibility measure.

At block 406, based on the set of calculation rules, the compatibility measuring engine 114 identifies user data and categories that are relevant in calculating compatibility measures or scores. In some embodiments, a compatibility measure is determined or calculated for each pair wise combination of the user and one of their network friends. In a typical compatibility calculation, the compatibility measuring process involves comparing data about each friend to the same or contextually similar data about the user, and calculating a compatibility measure or score. Referring back to FIG. 2, information about each friend in the list has been obtained and collected from the third party social network site through various methods. The collected information may be associated with the user information and stored in the database for the similarity or compatibility calculation for the user. As illustrated at block 406, the compatibility measuring engine 114 identifies the friend's information (data) that is relevant in the compatibility measure calculation. At block 408, the compatibility measuring engine 114 applies the calculation rules to compare the identified user data and the friend's data.

As discussed above, there are various ways to calculate compatibility between two sets of data. The measure of similarity or compatibility may be the result of evaluating a specified metric (e.g., a quantity used to characterize a set of data) for the user's information and comparing that to the value of the same metric for the friend's information. In such a method, the metric is evaluated for the user's and each friend's data set separately, and then the values of the metric are compared to obtain a measure of the similarity or compatibility between the user and each friends (generally by application of a heuristic to the metric values). In addition to evaluation of a defined metric, the measures may also result from application of a statistical analysis technique to the data (e.g., a center of gravity analysis or a clustering technique to determine how closely each network member's musical tastes are to a defined standard), or a curve or surface fitting technique to determine an equation or surface that can be used to characterize the user's information, such as music library, listening habits, movie preferences, downloaded media contents, book preferences, activities/affiliation, interests, particular type of photos, etc.

A similarity or compatibility measure may also be obtained by performing an analysis of the user's and the friends' data as groups, the contents of which are compared relative to each other. A wide variety of suitable methods can be used, including similarity calculation methods typically used in the area of Collaborative Filtering. Such methods include the Cosine-Based Similarity method, for example. Possible compatibility calculations, measures, heuristics, algorithms, and methods include, but are not limited to, the following:

### “Percentage-Overlap” Measure

In one embodiment, a percentage-overlap measure may be implemented for similarity/compatibility calculation. The percentage-overlap measure may determine the number of shared/overlapping tastes, as a % of all data or similar category of data about each user. For example, if each has 10 favorite artists, and 3 overlap, the compatibility score is 30%.

### Cosine-Based Similarity

In one embodiment, a cosine similarity measure and/or variants thereof may be implemented by calculating the “Cosine Similarity” between the user and the friend based on their tastes. Other variants of this approach include Correlation-based Similarity or Adjusted Cosine Similarity, and other measures used as part of collaborative filtering or recommendation processes.

### Modified Cosine-Based Similarity

In one embodiment, the cosine similarity measure may be modified to incorporate contextual information or other knowledge about the inherent similarities or relationships between the data. For example, if Joe likes “U2” and John likes “Coldplay”, the percentage-overlap method or a typical cosine-similarity algorithm (or variants thereof) would show no compatibility between Joe and John. However, if the cosine-similarity measure or other measure is modified to take into account contextual information regarding the degree of similarity between U2 and Coldplay, then the similarity measure will provide a different and more relevant result.

One possible method of incorporating and utilizing such contextual information and other measures including the cosine-similarity measure are described in greater detail in U.S. patent application Ser. No. 11/511,684 entitled “System, Apparatus And Method For Discovery Of Music Within A Social Network”, filed Aug. 28, 2006, the contents of which is hereby incorporated by reference in its entirety.

As noted, the service server 106 may also rely on evaluation of other suitably defined metrics or analysis techniques that can be used to characterize the data. For example, such metrics or analysis techniques include those utilized in Collaborative Filtering or Collaborative Recommendation methods, and a variety of forms of statistical analysis. For example, such methods include similarity measures that are used as the basis for generating recommendations. Such similarity measures are used to quantify the relative similarity (or closeness) of two data sets, typically by expressing a characteristic of such data sets as an n-dimensional vector or n-by-m dimensional matrix. Examples of such similarity measures include those termed the Cosine-based Similarity, Correlation-based Similarity, and Adjusted Cosine Similarity methods.

In one embodiment, the compatibility measuring engine 114 may enable a user to select what type or category of data should be processed to generate a compatibility score (e.g., only hobbies, favorite songs/artists, most recently read books, etc.). Further, a user may desire to select the process by which the compatibility measure is generated, or know how the measure would vary if determined by different processes.

At block 410 the compatibility measuring engine 114 calculates the compatibility measure, or score for the friend based on the results from block 408. In some embodiments, the compatibility measuring engine 114 may use several different methods to calculate the compatibility measure or score. The calculated compatibility measure or score is stored at block 412 and returned to the main routine 200 (sub-block 208) at block 414.

It is noted that in addition to the determination of a compatibility measure between a user and one or more friends within a social network, the service server 106 may also process information about a user or friend such as tastes, preferences, hobbies, interests, favorite music, movies, events, etc. to support providing advertisements, offers, promotions and the like to either the user or friend, or both. The advertisement, offer, promotion, etc. may be targeted to the user and/or friend based on personal information about the user or friend (birth date, location, marital status, socio-economic data) and/or based on the user or friend's preferences or interests as indicated by information on their social network pages. As an example, notice of an event or tickets to a concert could be advertised or offered based on a user or friend's interests or list of favorite artists. Further, based on a sufficient degree of similarity or compatibility between a user and friend, a common advertisement or other information could be presented to both as a way of encouraging activity within the social network.

As discussed, the system and methods determine a compatibility measure between a user and a friend of the user within a third party social network where the user and the friend are members. In some embodiments, this is accomplished by obtaining access to a list or other identification of the user's friends within the social network, and then accessing data about each friend that is relevant to determining a desired form or type of compatibility measure. The compatibility measure may be determined in a multitude of ways, and is not limited to those expressly described herein.

One of benefits of measuring compatibility in this manner may be the convenience provided to the user. For example, if a user has designated hundreds of friends within a social network, it can be challenging to discover his/her most compatible friends. In some cases, the user may not be able to review information about each friend to determine compatibility. In some instances, the user may not know what information about the friends needs to be compared to determine compatibility. The compatibility measuring engine 114 may efficiently help the user in finding his/her most compatible friends among many friends with a social network that is implemented independently from the service server 106 or the compatibility measuring engine 114. In contrast, conventional methods of determining a compatibility measure typically require the user and each of the user's friends to belong to a specific network within which a content-specific measure is determined. Such method for the compatibility measure on network-specific data or content may be useful but can not determine compatibility measure based on data outside of that specific network, i.e., a third party social network.

In an advantageous aspect, the most compatible friend's information may be used in many collaborative ways. In some instances, the user may not have provided information about certain categories of preference but the most compatible friend(s) has. Such information about the friend may be used for target marketing or recommendation for the user or the user's other friends. For example, John has a most compatible friend who likes Indian food. Consider a situation where John does not provide any preference about the food or information whether the user likes Indian food. Some promotion about a new Indian restaurant may be presented to John since the most compatible friend indicates that he/she likes Indian food. Alternatively, the service server 106 may confirm John if John also likes Indian food and store John's answer (likes Indian food, dislikes Indian food, or has no preference, etc.) in user preference information.

In one embodiment, aggregated preference information among the most compatible friends may be shared for recommendation of a product, a show, promotion, etc. The preference information of several most compatible friends may be collected, grouped and used. For example, John has preferences of “A, B, C, and D” and John's most compatible friend Susan has preferences of “A, C, D, F, and G.” Susan's most compatible friend Lisa has preferences of “C, D, F, G, and K.” The aggregated preference information for John, Susan, and Lisa may be “A, B, C, D, F, G, and K.” The service server 106 may also use such information as John, Susan and/or Lisa's preference information for to support providing advertisements, offers, promotions and the like.

In one embodiment, the system and method may assist a user in discussing or communicating about a particular topic of interest with their social network friends. In some cases, a user may want to post a movie review to his or her friends, or to recommend a song by a new artist. In such cases, rather than requiring the user to pick and choose every friend to engage in such communication, the method and system may present a subset of friends who have the greatest compatibility with the topic of interest. For example, if a user wants to recommend a song by Radiohead, discuss a Coldplay concert, or write a review about an action movie by Tom Cruise, the method and system may determine which friends are most compatible with the topic at hand (in this case, “Radiohead”, “Coldplay”, or “Tom Cruise”) through calculating compatibility measures based on the selected categories and topics. Upon seeing this selection of compatible friends, the user may then either choose to engage all of them in the communication, or to select a subset of them to engage in the communication.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof.

The environment can include a variety of data stores and other memory and storage media as discussed above. These can reside in a variety of locations, such as on a storage medium local to (and/or resident in) one or more of the computers are remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the description as set forth in the claims.

What is claimed is:

1. A method for providing a compatibility measuring service for a user on a third party social network, the method comprising:
obtaining, from the user, a permission to access the third party social network;
accessing the third party social network using the permission to obtain information relating to the compatibility measuring service,
wherein the obtained information includes information about the user and a list of friends designated by the user within the third party social network; and
for each friend in the list:
obtaining information about the friend from the third party social network, wherein the information about the friend includes one or more information about preferences, user profile, interests, hobbies, likes and dislikes of the friend;
processing the obtained information to identify a set of information relevant to calculating a compatibility measure between the user and the friend; and
determining the compatibility measure based on the identified set of information and the information about the user.

2. The method of claim 1, further comprising, upon determining the compatibility measure, storing the determined compatibility measure and identification information about the friend.

3. The method of claim 1, further comprising:
obtaining criteria to filter compatibility measures, the criteria being selected based on the request for the compatibility measuring service;
filtering, based on the criteria, the compatibility measures determined for the list of friends to generate a resulting list of friends; and
presenting the resulting list of friends.

4. The method of claim 3 wherein one of the criteria includes filtering out friends who have a value of the compatibility measure that is lower than a threshold value.

5. The method of claim 3, wherein one of the criteria is provided by the user.

6. The method of claim 1, further comprising:
sorting the compatibility measures determined for the list of friends;
generating a resulting list of friends in order of sorting; and
presenting the resulting list of friends.

7. The method of claim 6, further comprising:
after sorting, determining the most compatible friend; and
presenting the most compatible friend.

8. The method of claim 1, further comprising:
determining a compatibility level for each friend, wherein the friend has a compatibility measure in a range that is predefined for the compatibility level;
generating a resulting list of friends in order of the compatibility levels; and
presenting the resulting list of friends.

9. The method of claim 1, wherein accessing the third party social network includes using an API interface to directly access the third party social network.

10. The method of claim 9, wherein the API interface is provided by the third party social network.

11. The method of claim 1, wherein accessing the third party social network includes using screen scraping to obtain the list of friends.

12. The method of claim 11, wherein the permission is a user's login credential information.

13. The method of claim 11, wherein the information about the friend is obtained through screen scraping of a Web page in the third party social network.

14. The method of claim 1, wherein determining the compatibility measure further comprising:
applying a set of compatibility measure rules to the obtained information about the friend and the obtained information about the user.

15. The method of claim 14, wherein the set of compatibility measure rules is defined based in one or more of the following methods:
a percentage overlap method;
a cosine similarity method; and
a cosine similarity method modified to take into account contextual information.

16. The method of claim 1, further comprising obtaining, from the user, additional information relevant to determining compatibility between the user and the plurality of friends.

17. The method of claim 1, further comprising:
obtaining, from the user, a topic of interest for communication;
determining, from the social network, the list of friends who are most compatible with the topic of interest; and
presenting the resulting list of friends as choices to select for a communication about the topic of interest.

18. A system for providing a compatibility measuring service for a user on a social network, the system comprising:
a processor; and
a memory device including instructions that, when executed by the processor, cause the processor to:
receive a request for the compatibility measuring service;
obtain, from the user, a permission to access the social network;
access the social network using the permission to obtain the information relating to compatibility measuring service,
wherein the obtained information includes information about the user and a list of friends designated by the user within the social network; and
for each friend in the list:
obtain information about the friend from the social network, wherein the information about the friend includes one or more information about preferences, interests, hobbies, likes and dislikes of the friend;
process the obtained information to identify a set of information relevant to calculating a compatibility measure between the user and the friend; and
determine the compatibility measure between the user and the friend based on the identified set of information.

19. The system of claim 18, wherein the memory device further includes instructions that, when executed by the processor, cause the processor to:
obtain criteria to filter the determined compatibility measures, the criteria being set based on the request for the compatibility measuring service;
filter, based on the criteria, the compatibility measures to generate a resulting list of friends; and
present the resulting list of friends.

20. The system of claim 18, wherein the memory device further includes instructions that, when executed by the processor, cause the processor to:
sort the compatibility measures to generate a resulting list of friends; and
present the resulting list of friends in order of sorting and the compatibility measures.

21. The system of claim 20, wherein the memory device further includes instructions that, when executed by the processor, cause the processor to:
after sorting, determine the most compatible friend; and
present the most compatible friend.

22. The system of claim 18, wherein the memory device further includes instructions that, when executed by the processor, cause the processor to:
determine a compatibility level for each friend, wherein the friend has a compatibility measure in a range that is defined for the compatibility level;
sort the compatibility measures in order of compatibility levels to generate a resulting list of friends; and
present the resulting list of friends.

23. The system of claim 18, wherein accessing the third party social network include using an API interface to directly access the third party social network.

24. The system of claim 23, wherein the API interface is provided by the third party social network.

25. The system of claim 18, wherein accessing the third party social network includes using screen scraping to obtain the list of friends.

26. The system of claim 25, wherein the permission is the user's login credential information.

27. The system of claim 25, wherein the information about the friend is obtained through screen scraping.

28. The system of claim 18, wherein determining the compatibility measure further comprising:
applying a set of compatibility measuring rules to the obtained information about the friend and the obtained information about the user.

29. The system of claim 28, wherein the set of compatibility measure rules is defined based in one or more of the following methods:
a percentage overlap method;
a cosine similarity method; and
a cosine similarity method modified to take into account contextual information.

30. The system of claim 18, wherein the memory device further includes instructions that, when executed by the processor, cause the processor to: obtain from the user additional information relevant to determining compatibility between the user and the plurality of friends.

31. The system of claim 18, wherein the memory device further includes instructions that, when executed by the processor, cause the processor to:
obtain, from the user, a topic of interest for communication;
determine, from the social network, the list of friends who are most compatible with the topic of interest; and
present the resulting list of friends as choices to select for a communication about the topic of interest.

32. A method of determining compatibility between a user and a list of friends, the method comprising:
receiving a request from the user to determine a compatibility measure;
obtaining information about the user, wherein the information about the user includes information about a third party social network where the list of friends are specified, the user's preference information, and the user's profile information;
in response to receiving the request from the user,
obtaining the list of friends from the third party social network;
for each friend in the list:
accessing information about the friend from the third party social network; and
determining a compatibility measure between the user and the friend based on the information about the friend and the information about the user;
sorting the list of friends in order of the compatibility measures; and
displaying a subset of the sorted friends along with the corresponding compatibility measures.

33. The method of claim 32, wherein accessing information about the friend from the third party social network further comprises accessing information about one or more of preferences, interests, hobbies, likes and dislikes specified by the friend.

34. The method of claim 32, wherein determining a compatibility measure between the user and the friend further comprises using contextual information relating information about the user and the friend to determine the compatibility measure.

35. The method of claim 32, wherein determining a compatibility measure between the user and the friend further comprises determining the compatibility measure using one or more of the following methods:
a percentage overlap method;
a cosine similarity method; and
a cosine similarity method modified to take into account contextual information.

36. The method of claim 32, further comprising:
presenting to the user an advertisement, promotion or related content based on the compatibility measure.

37. A server for determining compatibility between a user and a plurality of friends, wherein the user and the plurality of friends are members of a social network that is implemented independently from the server, the server comprising:
a database for storing information about the user, and a set of compatibility rules; and
a computing device communicatively coupled to the database, the computing device is operable to:
obtain permission from the user to access information about the user from the social network;
upon obtaining the permission, access the social network to obtain information related to the user, wherein the information related to the user includes a list of friends designated by the user within the social network and information about the user;
for each friend in the list:
access information about the friend from the social network;
calculate a compatibility measure between the user and the friend based on the information about the friend and the information about the user; and
store the values of the compatibility measure that are determined and identification information of the friend to the database;
generate an output based on the calculated compatibility measures; and
present the user with the generated output.

38. The server of claim 37, wherein the information about the friend is accessed through the identification information of the friend included in the list.

39. The server of claim 37, wherein the computing device enables the user to specify criteria for generating the output.

40. The server of claim 37, wherein the computing device obtains, from the user, additional information relevant to determining compatibility between the user and the plurality of friends.
